(19) United States
(12) Patent Application Publication
(10) Pub. No.: US 2005/0086002 A1
(43) Pub. Date: Apr. 21, 2005

(54) Vehicle data bus system with positioning unit

(75) Inventors: Martin Keppler, Horb (DE); Martin Mayer, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/922,152

(22) Filed: Aug. 20, 2004

(30) Foreign Application Priority Data
Aug. 23, 2003 (DE) 103 38 766.8

(51) Int. Cl. G01C 21/26

(52) U.S. Cl. 701/213; 701/216

(57) ABSTRACT

A vehicle data bus system comprises a data bus to which several bus subscribers are connected for data transmission purposes. A positioning unit is provided as a bus subscriber and is equipped to determine at least vehicle position data and to transmit the determined vehicle position data to the data bus. The positioning unit comprises a positioning sensor system, which contains at least one GPS receiver and gyro-data detection means (12) in the form of a gyroscope or in the form of means for bus-side reception and evaluation of gyro-data. The positioning unit is also equipped to determine solar position data using the determined vehicle position data, and to transmit the determined solar position data to the data bus.

### BACKGROUND AND SUMMARY OF THE INVENTION

This application claims the priority of German patent document 103 38 766.8, filed Aug. 23, 2003, the disclosure of which is expressly incorporated by reference herein.

The invention relates to a vehicle data bus system which connects a plurality of bus subscribers, including a positioning unit the latter being in the form of a position sensor system with at least one GPS receiver.

German patent document DE 199 44 177 A1 discloses such a vehicle data bus system, in which the positioning unit comprises at least one GPS receiver and means for vehicle position determination. The positioning unit is furthermore in a position to transmit obtained data to the data bus.

German patent document DE 37 33 764 A1 discloses a device for determining solar position data (that is the position of the sun relative to the vehicle), which data are made available to a positioning unit, and German patent document DE 43 05 446 A1 describes how solar position data can be used to improve the visibility conditions with respect to the display instruments. It also discloses the use of solar position data for controlling an air conditioning system. In addition, German patent document DE 196 20 779 C1 describes a vehicle lighting assembly which comprises means for determining the solar position using the vehicle position.

German patent document DE 198 37 160 C2 provides a light sensor system that is used for automatically switching vehicle light on and off.

One object of the invention is to provide a vehicle data bus system with increased functionality.

This and other objects and advantages are achieved by the vehicle data bus system according to the invention, in which the positioning unit also provides solar position data via the data bus. Characteristically the positioning unit contains the components that are used for vehicle position determination purposes in a form that is largely integrated into a single sub-assembly. The positioning sensor system is integrated at least partially in the positioning unit and is also coupled to the data bus. In this manner the positioning unit obtains the data required for vehicle position determination at least partially internally and also via the data bus.

In addition to the vehicle position data according to the invention, the positioning unit is equipped to determine the position of the sun relative to the vehicle from the vehicle position data. These determined solar position data are coupled into the data bus by the positioning unit and thus made available in a flexible fashion to the other bus subscribers via the data bus as needed, where they can be obtained by the additional vehicle-based bus subscribers. In this manner solar position data can be used in standardized form for different vehicles and in different countries without extensive adaptation measures.

Optionally the solar position data can also be received by communication components as bus subscribers, and can be transmitted via a wireless communication channel to remote, vehicle-external components.

In addition to the position data obtained from the GPS data, optionally an algorithm for coupling positioning with input variables can be provided in the positioning unit for determining a travel direction and a distance. If a digital card is provided in one of the bus subscribers that are connected to the data bus (especially in an optionally installed navigation system) then an algorithm can be provided for adjusting a trip based upon a digital card of a travel route network—“Mapmatching”. Depending on the design of the data bus system, one of the bus subscribers can also comprise a magnetic field probe, especially an electric compass.

Either the orientation of the motor vehicle can be determined from the data available on the data bus, or that information is available on the data bus. The orientation of the motor vehicle and the position of the sun relative to the vehicle can be used to determine the direction from which the motor vehicle is exposed to solar radiation. Proceeding from position data that comprise the orientation of the vehicle and from solar position data, in a beneficial embodiment of the invention the direction of solar irradiation into the vehicle is determined. These determined incident solar radiation data can be a component of the solar position data and can be made available on the data bus.

In a beneficial embodiment of the invention, the solar radiation data are determined by the positioning unit and made available as part of the solar position data by the positioning unit on the data bus.

Alternatively or in addition, it is also possible for another bus subscriber to receive solar position data and data about the orientation of the vehicle via the data bus, and to determine the solar radiation data from them.

The direction of solar irradiation into the vehicle can be used, for example, to deduce information as to how strongly the temperature in the vehicle will rise and/or what types of visual obstructions may be presented to the driver by the sun.

According to another advantageous embodiment of the invention, a digital card is available in one bus subscriber of the data bus system, which also contains information about elevation data, so that a horizon line of the terrain profile can be determined. (Such a determination of the horizon line is described for example in German patent document DE 4323081 C2.) The current horizon line can be used to determine whether the sun is located above or beneath it. The inclusion of elevation data here is beneficial since it allows a determination as to whether the sun is located, for example, behind a mountain. The elevation data stored in the digital card refer beneficially not only to the terrain profile, but also to the terrain. Thus, for example, the “skyline” of a city can be viewed from the vehicle, as well as the solar position in relation thereto can be determined. It can be determined whether the sun is hidden behind a tall building or behind the development area of a city.

In a beneficial embodiment of the invention, unit means for determining the current altitude of the vehicle above sea level (NN) are also provided in the positioning unit. When determining position data of the vehicle then beneficially also the altitude of the vehicle above sea level is determined.

Other objects, advantages and novel features of the present invention will become apparent from the following detailed description of the invention when considered in conjunction with the accompanying drawings.

### BRIEF DESCRIPTION OF THE DRAWINGS

FIG. 1 is a conceptual block diagram of a vehicle data bus system with a system for solar position determination; and

FIG. 2 is a flow diagram that illustrates a method for solar position determination.

### DETAILED DESCRIPTION OF THE DRAWINGS

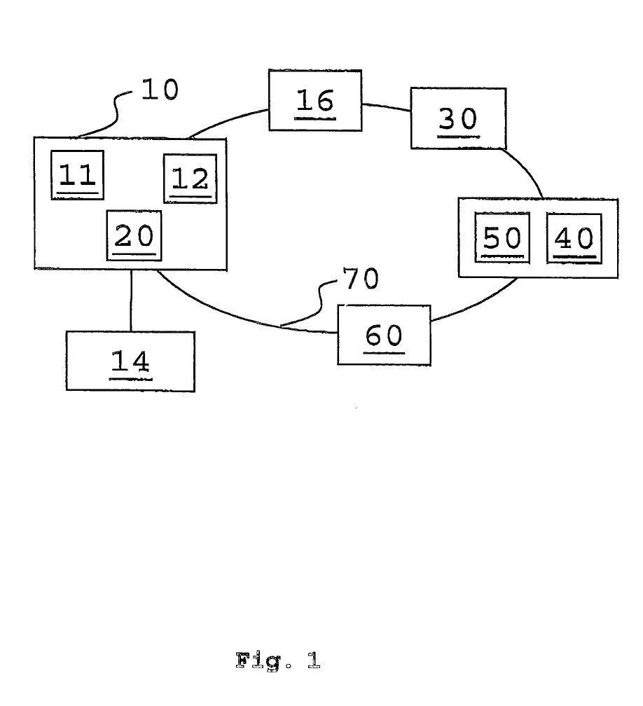

FIG. 1 is a diagrammatic depiction of a vehicle data bus system 10 with a positioning unit, in which several bus subscribers are connected to one data bus, including a navigation unit 16, a device 30 for determining the necessity of supporting the driver, a unit comprising the camera 50 and laser diode 40 of a night vision system, as well as a display and operating unit with monitor 60. (The term night vision system is used herein to refer generally to a system for improved vision in a vehicle. It shall not be understood in a restrictive sense and comprises the use of a night vision system to improve visibility both in the day and at night.) The laser diode 40 is operable in a known manner to radiate laser light with a wavelength outside the visible spectrum in a specified spatial angle region, and the camera 50 observes the same spatial region. Images acquired by the camera are displayed on the display unit 60.

Optionally further units, such as e.g., a light control system, an air conditioning system, a driving dynamics/wheel slippage control system, an engine control unit and/or a transmission control unit can be connected. The positioning unit 10, which can be installed uniformly, contains for example a GPS receiver 11 and a gyroscope 12 in integrated form.

The devices 10, 16, 20, 30, 40, 50 and 60 can be integrated as several units in one housing and/or be cross-linked by a data bus. Topology, discrete connection and/or data bus combinations are feasible as well. The data bus can for example be designed as a CAN bus or as an optical bus such as e.g. D2B (domestic digital bus) or MOST (media oriented systems transport).

An external GPS antenna 14, which is arranged in a suitable position on the vehicle, is connected to the GPS receiver 11. The positioning unit 10 is coupled into the data bus 70 via an appropriate bus interface and reads for example wheel speed data and/or forward/backward travel direction data from said bus. The wheel speed data can be supplied for example in the form of speed sensor pulses per time unit by a driving dynamics/wheel slippage control system, which also obtains these data for its own use, as is known. The driving dynamics/wheel slippage control system can be eg., an anti-locking system (ABS) or a driving dynamics control system used by the applicant under the abbreviation ESP (electronic stability program). The forward/backward travel direction data indicate whether the vehicle is currently traveling forward or backward and can come, for example, from reverse gear detection devices, which detect whether the reverse gear has been engaged.

To the extent that the positioning unit 10 does not obtain the data required for a position determination (ie., positioning) from the data bus, the data are supplied by the integrated position sensor units, specifically GPS data from the GPS receiver 11 and gyro-data from the gyroscope 12. In the positioning unit 10 vehicle position data are determined with its positioning accuracy classification (positioning quality), travel direction angle data, travel speed data and elevation data indicating the current altitude of the vehicle above sea level (NN). Moreover time determining means, which provide highly accurate time information, are contained in the positioning unit 10. In addition to actual angle information, the travel direction angle data also contain offset, drift and scaling factor information.

The positioning unit 10 further comprises means 20 for a solar position determination in relation to the vehicle, which information is issued by the positioning unit 10 to the data bus 70 and is available to the other bus subscribers.

In a beneficial embodiment of the invention the solar position data transmitted via the data bus 70 are received by a unit 30 which evaluates these data and determines whether visibility support is necessary. As a result of the evaluation the components 40, 50, 60 are activated, and the corresponding method for visibility support is executed.

In a further beneficial embodiment of the invention the solar position data are received via the data bus by further bus subscribers, such as a light control unit and/or an air conditioning system, and are evaluated.

The positioning unit sends the described determined data to the data bus 70, where they are available to the remaining bus subscribers. A connected engine and/or transmission control unit can obtain in particular the elevation information that is made available by the positioning unit 10 on the data bus 70 and thus requires no elevation sensor of its own. When newly starting the vehicle, it is beneficial to use the last elevation value present when the vehicle was turned off until current elevation data are available again.

As illustrated in the above explanations, the positioning unit 10 processes several pieces of parallel input information (specifically the internally obtained GPS data, the internally obtained gyro-data or gyro-data received via the bus, and wheel speed data received via the data bus 1), and with the help of the wheel speed data, it also fulfills an odometer function.

Optionally the data bus system comprises a navigation unit 16 as another bus subscriber, which receives the various data that are supplied by the positioning unit 10 via the data bus 70, and subjects especially the received position data to a conventional map matching process. The vehicle position determined by the positioning unit 10 is compared to data of a digitally stored route network card. With this process the navigation unit 16 determines a possibly corrected, exact vehicle position with a new positioning accuracy classification (positioning quality) and sends that information together with route network information (such as city and street names) to the data bus 70. To the extent that they require vehicle position data, the bus participants that are connected to the data bus 70 can use the exact vehicle position data made available by the navigation unit 16 for this purpose.

Moreover the navigation unit 16 sends to the data bus 70 position correction data, which represent the possible deviation of the exact vehicle position determined by it from the vehicle position that was determined by the positioning unit 10. The positioning unit 10 can take these back-coupled position correction data or correction parameters from the data bus 70 and use them for an appropriate correction of its positioning determination in order to improve the positioning determination accuracy. The accuracy of the data that are deduced from the position (such as the solar position data) is also increased in this manner.

Optionally the positioning unit 10 may not contain a gyroscope 12. In this case the positioning unit 10 comprises means for a bus-side reception and evaluation of gyro-data of a driving dynamics/wheel slippage control system (e., from an ESP control unit). This leads to satisfactory results when the gyro-sensor of the driving dynamics/wheel slippage control system exhibits sufficient accuracy or performance and reliability. The driving dynamics/wheel slippage control system makes the determined gyro-data available on the data bus 70, from which they can be obtained by the positioning unit 10.

Optionally the positioning unit 10 can contain an integrated GPS antenna 14, eliminating the necessity of a GPS antenna that is mounted separately on the vehicle and connected to the positioning module.

The solar position data are especially advantageous when used in connection with an exterior light control of the vehicle. For example, in this manner rear flat incident solar irradiation can be determined, and upon detection of such rear flat incident solar irradiation the low-beam light can be activated automatically.

The use of positioning data and solar position data, which are made available via the data bus, is also beneficial in connection with an air conditioning system. Based upon position data and solar position data, the direction of incident solar radiation into the vehicle is determined for an air conditioning control system. These incident solar radiation data can be a component of the solar position data. The incident solar radiation data are then beneficially generated by the means 20 for solar position determination. Alternatively or additionally, the solar radiation data can be determined in the actual air conditioning system from data that are received via the data bus, especially position data and solar position data. The means for determining the direction of incident solar radiation into the vehicle are then arranged in the air conditioning system. The determination of the direction of the incident solar radiation as an input variable for the air conditioning controls allows a very prompt response to changing climatic conditions in the motor vehicle. For example a starting direct solar radiation is generally associated with a prompt temperature increase in the interior of the motor vehicle so that with the knowledge about the direction of incident solar radiation the temperature increase can be avoided or compensated early on through the activation of a cooling phase. A more effective control of the air conditioning system for the comfort of the passengers in the motor vehicle is therefore guaranteed.

The information regarding position, solar position, positioning accuracy classification (positioning quality), travel direction angle, direction of rotation, elevation, vehicle tilt etc. that is made available in standardized form by the positioning module can be used via the data bus in a flexible manner by the various systems that are based on positioning information, e.a., for light control, air conditioning control, emergency services, taxi services, navigation, curve warning system, random vehicle traffic position determination, driving dynamics control, anti-locking system, drive system slippage control, transmission, engine electronics, instrument cluster and comfort information.

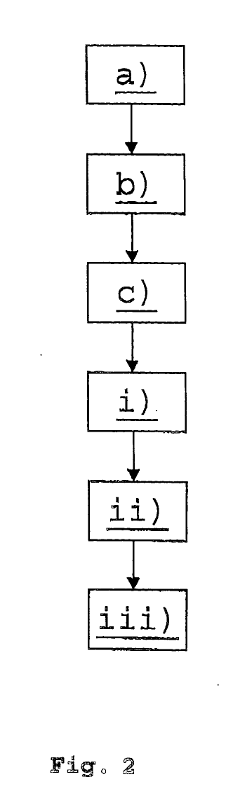

FIG. 2 is a diagrammatic depiction of a method for determining solar position to be used in a night vision system. In step a), the current position of the vehicle is determined, and based upon these data, the solar position in relation to the vehicle is determined in step b), by means of the devices used to determine the position of the sun relative to the vehicle 20.

With respect to the use of the solar position data for a night vision system it is especially beneficial to determine whether the sun in relation to the vehicle is located above or beneath the horizon, as viewed from the vehicle. If in step b) it is determined, for example, that the sun is located beneath the horizon, then in step c) the necessity of activating the arrangement for improving visibility in the vehicle (and hence of initiating the method for improving visibility) is determined in the device 30. In this manner a so-called night vision system is implemented, which is activated only as needed (ie., at night). Compared to the sole evaluation of a light sensor this offers the advantage that the night vision system also remains active when the current surroundings of the vehicle are illuminated (e.g., at an intersection or in a parking lot). It is beneficial in such situations to keep the night vision system activated, since this way also the currently non-illuminated areas continue to remain visible to the user. At an intersection these are, for example, the areas on the sidewalks or peripheral areas of the road. In the case of parking lots this would be, for example, a peripheral area of the parking lot.

In the determination of necessity in step a) additionally the data from a light sensor may optionally be included. For this purpose the light sensor is connected to the device 30 for data transmission purposes.

The night vision system operates pursuant to a method with the steps i), ii), and iii). The night vision system employs the means 40, 50 and 60. The operating principle of the night vision system is described for example, in German patent document DE 40 07 646 A1 or in German patent document DE 10126 492 A1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A vehicle data bus system comprising:
a data bus;
a plurality of bus subscribers connected to the data bus for data transmission purposes; and
a positioning unit connected to the data bus as a bus subscriber, said positioning unit comprising a position sensor system which contains at least one GPS receiver, and being equipped to determine at least vehicle position data and to transmit determined vehicle position data to the data bus; wherein,
the positioning unit includes means for determining solar position data based on the determined vehicle position data, and for transmitting the determined solar position data to the data bus;
said positioning unit also receives solar position data from the data bus;
as an additional bus subscriber a device is provided, which determines the need to support a driver of the vehicle by activating an arrangement for improving visibility in a vehicle; and
the arrangement for improving the visibility in a vehicle comprises a camera for observing an angular spatial area and a display device in the interior of the vehicle for displaying the images of the camera.

2. A vehicle data bus system comprising:
a data bus;
a plurality of bus subscribers connected to the data bus for data transmission purposes; and
a positioning unit connected to the data bus as a bus subscriber, said positioning unit comprising a positioning sensor system which contains at least one GPS receiver, and being equipped to determine at least vehicle position data and to transmit the determined vehicle position data to the data bus; wherein,
the positioning unit includes means for determining solar position data based on determined vehicle position data, and for transmitting the determined solar position data to the data bus;
said positioning unit also receives solar position data from the data bus;
a digital card with stored elevation data is provided whereby the skyline of a surrounding vicinity can be viewed from the vehicle, and the solar position can be determined in relation thereto so that it can be determined whether the sun is currently hidden behind objects in the skyline.

3. The vehicle bus system according to claim 2, wherein the skyline is an urban skyline, and the objects include buildings whose elevation data is stored in the digital card.

4. The vehicle data bus system pursuant to claim 1 wherein the arrangement for improving visibility comprises:
means for radiating laser light with a wavelength outside the visible spectrum in a specified spatial angle region;
a camera for observing the spatial angle region into which the laser light is radiated; and
a display device in the interior of the vehicle for displaying the images of the camera.

5. The vehicle data bus system pursuant to claim 1, wherein a light control unit is provided as an additional bus subscriber, which light control unit receives solar position data from the data bus.

6. The vehicle data bus system pursuant to claim 2, wherein a light control unit is provided as an additional bus subscriber, which light control unit receives solar position data from the data bus.

7. The vehicle data bus system pursuant to claim 1, wherein an air conditioning unit is provided as an additional bus subscriber, which air conditioning unit receives solar position data from the data bus.

8. The vehicle data bus system pursuant to claim 2, wherein an air conditioning unit is provided as an additional bus subscriber, which air conditioning unit receives solar position data from the data bus.

9. The vehicle data bus system pursuant to claim 1, further comprising gyro-data detection means in the form of one of a gyroscope and means for bus-side reception and evaluation of gyro-data.

10. The vehicle data bus system pursuant to claim 2, further comprising gyro-data detection means in the form of one of a gyroscope and means for bus-side reception and evaluation of gyro-data.
